(19) United States
(12) Patent Application Publication
(10) Pub. No.: US 2025/0260348 A1
(43) Pub. Date: Aug. 14, 2025

(54) EDDY CURRENT BRAKE FOR LINEAR DRIVES

(71) Applicant: Integral Drive System AG, Freienbach (CH)

(72) Inventor: Alexander STOEV, Lachen (CH)

(21) Appl. No.: 18/854,947

(22) PCT Filed: Mar. 26, 2023
(86) PCT No.: PCT/EP2023/057748

§ 371 Date: Oct. 7, 2024

(30) Foreign Application Priority Data
Apr. 7, 2022 (CH) CH000392/2022

(51) Int. Cl. H02P 15/00; H02K 49/04

(52) U.S. Cl. CPC H02P 15/00; H02K 49/046

(57) ABSTRACT

A linear eddy current brake includes a brake plate and a moving rotor with magnets having magnet surfaces which generate inductions in the brake plate and induce eddy currents about the magnet surfaces. The brake plate is divided by slots in the brake plate into open segments insulated from one another which reduce the brake force of the eddy current brake (WBS). The open segments are electrically connected or short-circuited to increase the braking force of the WBS. The eddy currents of the segmented brake plate (S-brake plate) flow in the respective open segments and in a conductor region which connects the open segments on one face. The S-brake plate is functionally divided into a securing region, contact region, induction region, and a conductor region, and the regions of the S-brake plate, except the conductor region, are divided into segments which can be short-circuited by slots running in the transversal direction.

### CROSS-REFERENCE TO RELATED APPLICATIONS

This application is a national phase filing of, and claims priority to, International Patent Application No. PCT/EP2023/057748, filed in Mar. 26, 2023, which claims priority to Swiss Non-Provisional Application No. CH000392/2022, filed on Apr. 7, 2022, the contents of which are all expressly incorporated herein in their entirety and for all purposes.

### TECHNICAL FIELD

The present disclosure generally relates to eddy current brakes for linear drives.

### BACKGROUND

Eddy current brakes (WBS) for linear drives are used for linear drives in the cabins of roller coasters or in so-called free-fall towers. The WBS brakes the vehicles at the end of the ride in a fail-safe manner, as described in utility model DE 295 06 374 U1.

A WBS eddy current brake consists of a short, axially moving rotor with magnets and stationary, solid brake plates installed between the magnets.

The massive brake plates make it difficult to accelerate the cars at the start of a new train journey. The brake plates are therefore extended from the space between the magnets. The mechanical devices which extend the massive brake plates are complex and expensive. This paper presents a new method that allows the braking force of a WSB to be changed without retracting or extending the brake plates.

FIG. 1 shows the front view of an eddy current brake for linear drives according to the state of the art The eddy current brake WBS consists of a brake plate 1, a U-shaped slider 2 with the two magnetic strips 3, which carry the magnets 4, the induction space 5 between the magnets, and the angled mounting profiles 6, which fix the brake plate 1 on a stationary platform 7. The slider 2 moves along an axis of movement (linear axis). The three dimensions of the brake plate 1 are defined in relation to the linear axis (axis of movement) of the slider as follows:

The length of the brake plate 1 is aligned in the axial direction (along the linear axis, linear, i.e. here perpendicular to the plane of the drawing sheet), the height of the brake plate 1 is aligned in the transverse direction (transversal, i.e. in the plane of the drawing sheet from bottom to top), the width (thickness) of the brake plate 1 is aligned in the transverse direction (transverse, i.e. in the plane of the drawing sheet horizontally from left to right).

The magnets are defined by the magnet width bₘ, by the magnet height hₘ and by the magnet induction Bₘ. The magnetic area is equal to the product bₘ*hₘ. The magnets are alternately magnetized along the magnetic strip 3, i.e. from bottom to top in the plane of the drawing sheet in FIG. 1. The opposing magnets 4 are equally polarized, the inductions of the opposing magnets 4 add up in the induction space.

A brake plate usually consists of a copper alloy, is approx. 6 mm thick, approx. 40 cm high and approx. 60 cm long. State-of-the-art brake plate 1 has a solid design.

FIG. 2 shows a side surface of a solid brake plate 1, in which three magnetic surfaces 12 and three eddy currents 13 are shown. The brake plate 1 is functionally divided into an induction area 10, a conductor area 9 and a profile area 11.

The hatched area 13 corresponds to a magnetic surface that is flooded by the induction Bₘ of the magnets. The moving magnets induce ring-shaped eddy currents 13, which enclose the magnetic surfaces 12 and slow down the slider.

The ring-shaped eddy currents 13 are excited in the induction area 10 and short-circuited by the conductor area 9 and profile area 11. Equation (1) applies as a first approximation for the braking force F_{ws} and for the eddy currents of the solid brake plate I_{ws}:

$${F}_{w s} ∼ {I}_{w s} ∼ {B}_{m} * {b}_{m}^{2} * {h}_{m} \qquad ( 1 )$$

The braking force F_{ws} and the eddy currents I_{ws} of a solid brake plate 1 are proportional to the magnetic induction Bₘ, the square of the width bₘ² and the height hₘ of the magnets.

The existing technical solutions utilize the dependence of the braking force on the magnetic induction Bₘ-see equation (1).

The method according to the patent specification EP 3 451 516 A1 proposes to move a magnetic strip of the slider axially by a magnet width bₘ.

The inductions of the magnets, which lie opposite each other in the induction space, are no longer equal but opposite after the magnetic bar has been moved. The inductions of the magnets in the induction space cancel each other out and the braking force decreases. If the magnetic strip is moved back by the magnet width bₘ, the induction Bₘ in the induction space increases and the braking force of the eddy current brake WBS increases.

In patent U.S. Pat. No. 4,482,034, it is proposed to rotate part of the magnetic poles and thus modulate their braking effect. In DE 1 053 687 of the German Patent Office, a linear displacement of the magnets is proposed, similar to patent specification EP 3 451 516 A1. In CN 105591523A, rotating disks are slowed down by superimposing the magnetic field of the magnetic poles with the magnetic field of current-carrying coils. By changing the current direction of the coils, the magnetic flux and thus the braking effect of the poles is increased, reduced or switched off. In another method, the braking force is changed by retracting or extending the brake plate from the induction chamber. If the solid brake plate is outside the induction chamber, there is no braking force. The further the brake plate is immersed in the induction chamber, the greater the braking force of the solid brake plate.

The pressure accumulator and the valves are configured in such a way that the brake plates are retracted into the induction chamber in the event of a fault so that the full braking force is available in the event of a fault (fail-safe WBS). The energy required in the event of a fault is supplied by a pressure accumulator.

In the following, this above-mentioned prior art is critically evaluated: The device which displaces the magnetic strip (EP 3 451 516 A1, U.S. Pat. No. 4,482,034) is complex and costly due to the strong attractive forces between the magnetic strips. In addition, this device requires energy in the vehicle, which is not available in the cab of a roller coaster. For this reason, this method has not become established.

Controlling the braking effect of the magnetic poles using current-carrying coils is problematic because the coils are very large and the coil current causes losses and high temperatures. Furthermore, this method is only intended for rotating eddy current brakes. The device for retracting and extending the brake plates consists of pneumatic or hydraulically operated cylinders with pressure accumulators. This device must be able to absorb the full braking force and is therefore complex, bulky and expensive.

This criticism also applies to the pressure accumulator, which is required as an energy source for immersing the brake plate in the induction chamber.

### SUMMARY

In view of these disadvantages of the known designs, it is the task of the present invention to establish a method for controlling the braking force of a WSB which does not require the costly displacement of the brake plates.

A further task is to specify devices as required for the implementation of this method. A further task is to achieve a ratio of at least nine to one between the maximum and minimum braking force of the controlled WSB. A further task is to design the device so compactly that it is possible to replace an existing WSB with a WSB controlled according to the invention. These devices are intended to generate short circuits between the segments of an S-brake plate or to cancel these short circuits. A further task of the invention is to define the properties and topology of the brake plates of the controlled WBS.

The device for controlling the braking force should switch currents in the range of several 1000 A on and off, and the resistance of the short circuits should only be a few milli-ohms. High losses and impermissibly high temperatures should be avoided.

If possible, the device should be able to handle up to 105 switching operations without failure. It must also be fail-safe, i.e. the maximum braking force must be generated in the event of a fault.

The solution to the technical problem includes a method according to the features of claims 1 to 3. The method can be implemented with devices according to claims 4 to 14. The solid brake plate is thus divided into segments according to the invention. These segments are either short-circuited in order to achieve a large braking force, or the short-circuits are opened in order to reduce the braking force. The topology of the segmented brake plate and the devices required for generating and eliminating the short circuits between the segments of the brake plate are presented below.

### BRIEF DESCRIPTION OF THE FIGURES

The figures are used to illustrate the basic problem and the devices for implementing the method are shown. These are described and explained below.

It shows:

FIG. 1 illustrates a front view of an eddy current brake for linear drives according to the state of the art;

FIG. 2 illustrates a solid brake plate with three eddy currents according to the state of the art:

FIG. 3 illustrates a segmented brake plate with open segments:

FIG. 4 illustrates a segmented brake plate with short-circuited short-circuiting surfaces:

FIG. 5 illustrates a structure of a switch;

FIG. 6 illustrates a contact conductor with spring contacts:

FIG. 7 illustrates a contact conductor with plug contacts.

### DETAILED DESCRIPTION

The aim of the present invention is achieved by dividing an area of the electrically conductive brake plate into several insulated segments. The segmented brake plate is hereinafter referred to as an S-brake plate. The segmentation is achieved by installing slots in the solid brake plate. The slots insulate the electrically conductive segments from each other-hereinafter referred to as open segments.

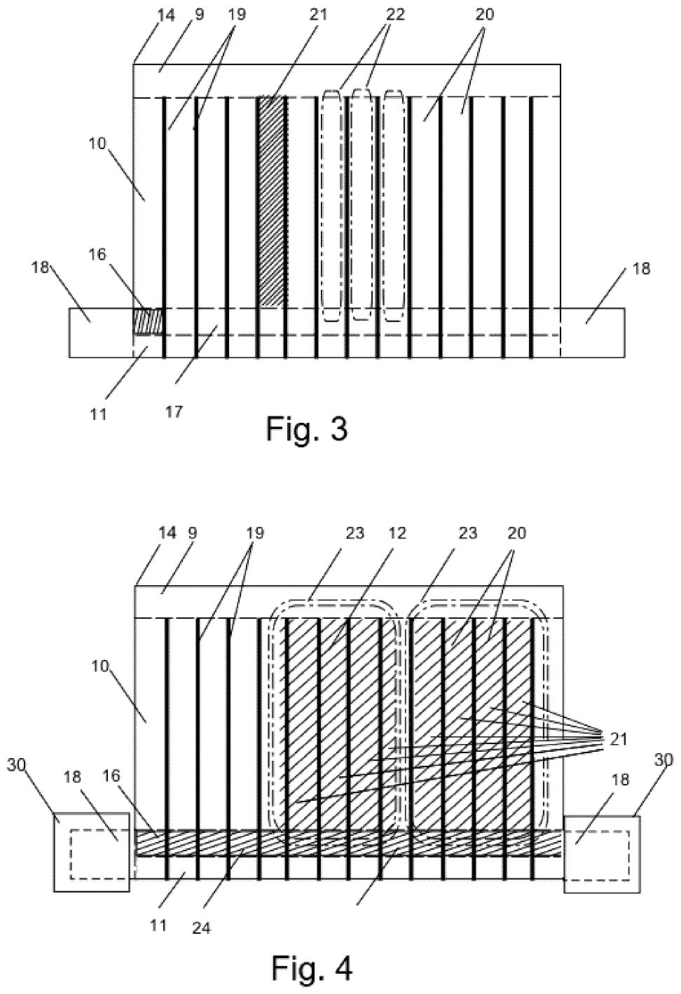

FIG. 3 shows a segmented brake plate with open segments 20. The S-brake plate 14 is functionally divided into a profile area 11, an induction area 10 and a conductor area 9. The height of the induction area 10 is equal to or greater than the magnet height hₘ.

The contact area 17 of the S-brake plate 14, which is located between the induction area 10 and the profile area 9, is divided into individual segments. The contact area 16 of a segment is shown with the hatched area 16 in FIG. 3. The two actuator areas 18 are intended for the attachment of actuators.

The slots 19 preferably run transversely through the induction area 10, through the contact area 17 and through the profile area 11. Only the conductor area 9 is not segmented. The slots define mutually insulated segments 20 with the segment width bₛ. The induction area 10 of the S-brake plate is covered by the magnetic induction.

The contact area 17 of the S-brake plate 14 cannot short-circuit any eddy currents as this area is interrupted by slots 19. The eddy currents 22 can only short-circuit within the segments 20. The eddy currents 22 therefore only enclose the respective active segment surfaces 21, which are shown hatched in FIG. 4. The braking force F_{ws1} and the eddy currents I_{ws1} of an S-brake plate 14 with open segments 20 are proportional to the square of the segment width bₛ The following applies:

$${F}_{ws 1} ∼ {I}_{ws 1} ∼ {B}_{m} * {b}_{s}^{2} * {h}_{m} \qquad ( 2 )$$

The greater the number of open segments 20, the smaller the segment widths, the eddy currents and the braking force.

The width of the slots 19 of an S-brake plate 14 is in the millimeter range, because the maximum voltage between two slots is less than 50 V. The slots 19 are preferably filled with an insulator to keep out impurities.

A solid brake plate with the dimensions of an S-brake plate 14 is referred to as an equivalent brake plate. The braking force of an S-brake plate 14 with open segments 20 can be reduced to less than 10% of the braking force of the equivalent brake plate.

The requirement for a minimum braking force is met if the conductor area 9 of the S-brake plate 14 is not affected by the leakage flux of the magnets of the rotor and no eddy currents are excited. This requirement is achieved with an induction range that is higher than the magnets.

FIG. 4 shows the hatched contact area 24 of a segmented brake plate 14 with short-circuited segments 20. According to the invention, the braking force of an S-brake plate 14 is greater when the segments 20 are short-circuited. The short-circuiting of the segments 20 takes place in the contact area 24.

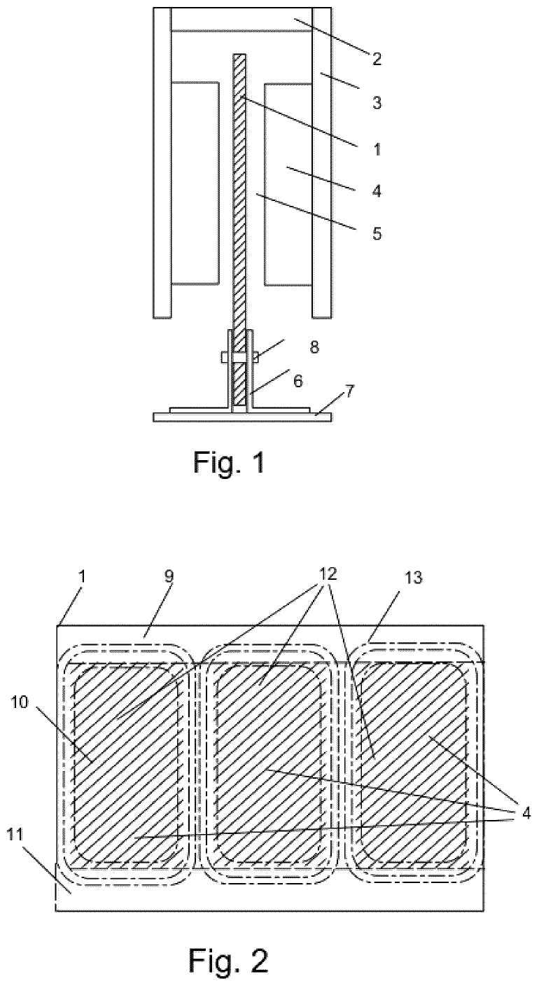

The eddy currents 23 of an S-brake plate 14 with short-circuited segments 20 enclose the magnetic surfaces 12, which are shown hatched in FIG. 4. The curves of the eddy currents I_{ws2} 23 of an S-brake plate 14 with short-circuited segments 20 are comparable to the curves of the eddy currents I_{ws} 13 of a solid brake plate, which are shown in FIG. 2.

Equation (3), which is equivalent to equation (1), applies to the eddy currents I_{ws2} and the braking force F_{ws2} of an S-brake plate 14 with short-circuited segments 20:

$${F}_{ws 2} ∼ {I}_{ws 2} ∼ {B}_{m} * {b}_{m}^{2} * {h}_{m} \qquad ( 3 )$$

It follows that the braking force of the S brake plate 14 with short-circuited segments 20 can reach up to 90% of the braking force of an equivalent brake plate.

In the following, the devices are described which are suitable for applying the method described above.

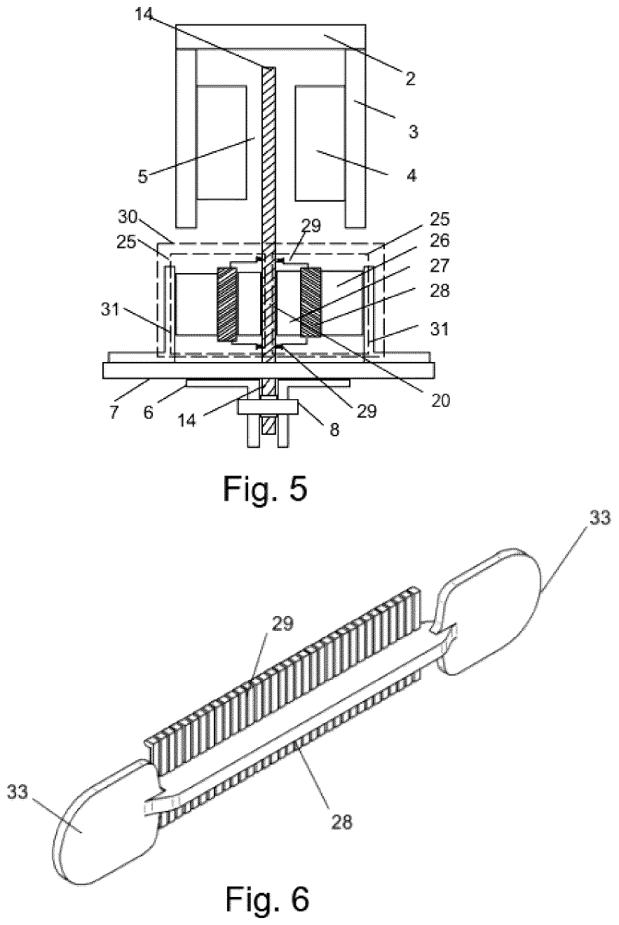

A device for carrying out the method according to claims 1 to 3 comprises two switches 30 which are mechanically connected to the two actuator regions 18 of the S-brake plate 14, as shown schematically in FIG. 4. One switch 30 comprises two pairs of actuators 25, as shown in FIG. 5.

A pair of actuators 25 consists of an ON actuator 26 and an OFF actuator 27, which move a contact conductor 28 with spring contacts 29. The OFF actuator 27 moves the contact conductor 28 with spring contacts to an OFF position, the ON actuator 26 moves the contact conductor 28 with the spring contacts to an ON position.

The segments 20 of an S-brake plate 14 are short-circuited by the two contact conductors 28 with the spring contacts 29. Two ON actuators 26 and two OFF actuators 27, which are attached to the actuator areas 18 of the S-brake plate 14, move the two contact conductors 28 with the spring contacts 29, as shown in FIG. 5.

When the two ON actuators 26 of an S-brake plate 14 move the two contact conductors 28 to the ON position, the spring contacts 29 are pressed against both contact areas of the S-brake plate 14 and short-circuit the segments of this S-brake plate 14. This state is called the ON state. The segments 20 are short-circuited in this state, as shown in FIG. 5.

When the two OFF actuators 27 of an S-brake plate 14 move the two contact conductors 28 to the OFF position, the connections between the spring contacts 29 and the segments 20 are interrupted. The short circuits of the segments 20 are thus opened. This state is called the OFF state, the segments 20 are open in the OFF state. The ON and OFF switches of an S-brake plate 14 are controlled synchronously.

As shown in FIG. 5, a housing 31 fixes the actuator pairs 25 of the S-brake plate 14 to the stationary platform 7. The S-brake plate 16 is fastened to the fastening profiles 6 with the fastening screws 8. The fastening profiles 6 fix the S-brake plate 14 to the platform 8.

The fastening profiles 6 and the fastening screws 8 are insulated from the S-brake plate 14. This prevents the fastening profiles 6 from short-circuiting the segments 20 of the S-brake plate 14.

FIG. 6 shows the structure of a contact conductor 28, which is connected to several individually spring-loaded contacts 29. The contact conductor 28 is equipped with an actuator area 33 at each of its two ends for the attachment of actuators. The contact conductor 28 is made of a highly conductive metal (e.g. copper). The spring contacts 29 are made of a highly conductive spring alloy (e.g. bronze).

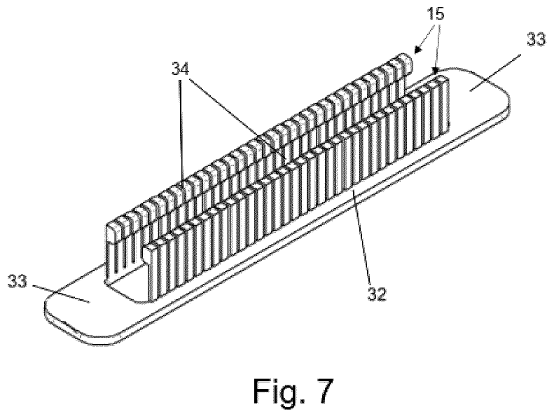

FIG. 7 shows an embodiment of a contact conductor 32 with two rows of individually spring-loaded plug-in contacts 34 with two actuator areas 33, provided for fastening the actuators. An S-brake plate is then clamped between the plug-in contacts 34.

The contact surfaces of the segments of the S-brake plate are divided into conductive and insulated contact surfaces when used in the contact conductor with its plug-in contacts 34. The insulated contact surfaces are covered with an insulating layer.

In the OFF state, the plug contacts 34 only contact the insulated contact surfaces: the segments remain insulated from each other. In the ON state, the plug contacts 34 contact the conductive contact surfaces of the segments and short-circuit them.

The two ON adjusters move the plug contacts 34 to the conductive contact surfaces of the segments, the OFF adjusters move the plug contacts 34 to the insulated contact surfaces of the segments.

The spring contacts 29, the plug contacts 34 and the contact surfaces of the segments 16 are coated with a contact material. The slots between the spring contacts 29 and plug contacts 34 are filled with an insulator. The slots 19 of the S-brake plate are filled with an insulator to keep out conductive contamination. The ON and OFF actuators can be realized with mechatronic, pneumatic or hydraulic actuators or with pneumatic or hydraulic cylinders for their actuation. The actuators are preferably designed with pneumatic or hydraulic cylinders for their movement.

The pressure accumulator and the valves for operating the hydraulic or pneumatic ON and OFF actuators are configured in such a way that the segments of the S-brake plate are short-circuited in the event of a fault.

The ON actuators of the fail-safe switch can be replaced or extended with one or more tension springs. In the event of a fault, the OFF actuators are deactivated and the tension spring automatically moves the contact conductors to the ON position.

The OFF actuators of the switch can be replaced or extended with one or more compression springs, the ON actuators remain unchanged.

The two contact conductors of an S-brake plate are moved synchronously to the ON or OFF position—and claim 13.

Position sensors are provided which report that the contact conductors have reached the ON position or the OFF position. Temperature sensors also register and report when the temperature of the spring or plug-in contacts has reached a maximum value. This prevents the spring or plug contacts from welding to the segments.

### LIST OF NUMERALS

1 Brake plate
2 Runner
3 Magnetic strip
4 Magnets
5 Induction room
6 Fastening profiles
7 Platform
8 Fastening screws
9 Ladder area
10 Induction range
11 Fastening area
12 Magnetic surfaces
13 Eddy currents
14 S-brake plate
15 -
16 Contact surface of a segment 20
17 Contact area
18 Control ranges
19 Slots between the segments 20
20 Segments
21 Segement surfaces
22 Eddy currents in the segments 20
23 Eddy currents around the magnetic surfaces
24 Contact area
25 Actuator pair
26 ON adjuster
27 OFF adjuster
28 Contact manager
29 Spring contact
30 Switches
31 Housing
32 Contact conductor with two rows of individually spring-loaded plug contacts 15
33 Control ranges
34 Plug contacts

1. A method for controlling the braking force of a linear eddy current brake (WBS), comprising:
generating inductions in at least one brake plate via magnetic surfaces of magnets included in at least one moving rotor;
inducing, by the magnetic surfaces, eddy currents around the magnetic surfaces of the magnets;
segmenting, via slots in the at least one brake plate, the at least one brake plate into segmented brake plates (S-brake plates);
dividing, via the slots in the at least one brake plate, the at least one brake plate into open segments which are insulated from one another and which reduce a braking force of the linear eddy-current brake (WBS) compared with a continuous brake plate;
electrically connecting or short-circuiting the open segments via pairs of actuators, wherein each pair of actuators comprises an ON actuator and an OFF actuator;
conveying a contact conductor into an ON position or an OFF position; and
based on the conveying of the contact conductor into the ON position or the OFF position, reducing the braking force of the WBS.

2. The method according to claim 1, wherein
the eddy currents of at least one S-brake plate of the S-brake plates only flow in the open segments and in a conductor area which connects the open segments on one side.

3. The method according to claim 1, wherein
the eddy currents enclose the magnetic surfaces of the -S-brake plates only in those of the S-brake plates with short-circuited segments.

4. A device for controlling a braking force of a linear eddy current brake, the device comprising:
at least one brake plate and at least one moving rotor with magnets having magnetic surfaces that generate inductions in the at least one brake plate and induce eddy currents around the magnetic surfaces, wherein slots in the at least one brake plate segment and divide the at least one brake plate into open segments which are insulated from one another and which reduce the braking force of the linear eddy-current brake (WBS) compared with a continuous brake plate, wherein the open segments are electrically connected or short-circuited by pairs of actuators, wherein each pair of actuators comprises an ON actuator and an OFF actuator with which a contact conductor can be conveyed into an ON position or into an OFF position to reduce the braking force of the WBS.

5. The device according to claim 4, wherein regions of the S-brake plate, except a conductor region of the regions of the S-brake plate, are divided by transversely extending slots into a plurality of segments which can be short-circuited, the device further comprising
switches configured to short circuit the plurality of segments, each having two pairs of actuators, wherein a first pair of actuators from the two pairs of actuators is arranged on a first side of the S-brake plate and a second pair of actuators from the two pairs of actuators is arranged on a second side of the S-brake plate wherein each pair of actuators comprises the ON actuator and the OFF actuator and each pair of actuators is configured to move a contact conductor into the ON position or into the OFF position; and
spring contacts associated with the contact conductor that are set in the ON position and configured to move into the OFF position, wherein the spring contacts, when in the ON position, make contact with contact surfaces of the plurality of segments and short-circuit the plurality of segments, and wherein one or more of the spring contacts of the contact conductor configured in the OFF position are insulated from the contact surfaces of the plurality of segments by an air gap and thus do not short-circuit the plurality of segments.

6. The device according to claim 4, further comprising:
fastening profiles of the S-brake plate; and
fastening screws insulated from the S-brake plate.

7. The device according to claim 5, wherein
the contact conductor comprises an electrically conductive material, wherein the spring contacts electrically connected to the contact conductor comprise an electrically conductive spring alloy, and wherein actuator regions are formed at both ends of the S-brake plate and are connected to one or more actuators from the two pairs of actuators.

8. The device according to claim 5, wherein the
contact conductor comprises two rows of individually spring-loaded plug contacts and two actuator regions, wherein the S-brake plate is inserted between the spring-loaded plug contacts and the spring-loaded plug contacts contact the contact surfaces of the plurality of segments of the S-brake plate, wherein the contact surfaces of the plurality of segments are divided into conductive and insulated contact surfaces, and wherein those of the spring-loaded plug contacts in the ON position contact the conductive contact surfaces and short-circuit the plurality of segments of the S-brake plate, while those of the spring-loaded plug contacts in the OFF position contact the insulated contact surfaces of the plurality of segments and thus do not short-circuit the plurality of segments.

9. The device according to claim 5, wherein
the spring contacts, the plug contacts and the contact surfaces of the plurality of segments are coated with a contact material, and the slots are filled with an insulator.

10. The device according to claim 5, wherein
each ON actuator and each OFF actuator includes a pneumatically or hydraulically controlled cylinder for its drive.

11. The device according to claim 5, wherein
each ON actuator is designed with one or more springs for its movement.

12. The device according to claim 5, wherein
each OFF actuator is designed with one or more springs for its movement.

13. The device according to claim 5, wherein
the contact conductors of the S-brake plate are synchronously conveyed into an ON or OFF state, and the plurality of segments of the S-brake plate is synchronously short-circuited or opened.

14. The device according to claim 5, further comprising:
position sensors configured to detect when the contact conductors reach the ON position and the OFF position; and
temperature sensors configured to detect a temperature of the spring contacts.

15. The method according to claim 1, further comprising:
electrically connecting the WBS; and
increasing the braking force of the WBS in response to electrically connecting the WBS.

16. The method according to claim 1, further comprising:
short-circuiting the WBS; and
increasing the braking force of the WBS in response to short-circuiting the WBS

17. The device according to claim 4, wherein the S-brake plate is functionally divided into a fastening region, a contact region, an induction region and a conductor region.

18. The device according to claim 17, wherein the fastening region, the contact region, and the induction region are divided by transversely extending slots into a plurality of segments.

19. The device according to claim 18, wherein the plurality of segments are short-circuited.

20. The device according to claim 4, wherein the braking force of the WBS is increased in response to electrically connecting the WBS or short-circuiting the WBS.
